(19) United States
(12) Patent Application Publication
(10) Pub. No.: US 2021/0277565 A1
(43) Pub. Date: Sep. 9, 2021

(54) METHOD AND APPARATUS FOR DETERMINING ESPECIALLY A CLEANING STRATEGY

(71) Applicant: Henkel AG & Co. KGaA, Duesseldorf (DE)

(72) Inventors: Arnd Kessler, Monheim am Rhein (DE); Christian Nitsch, Duesseldorf (DE); Lars Zuechner, Langenfeld (DE); Georg Wawer, Wien (AT); Alexander Mueller, Monheim (DE)

(73) Assignee: Henkel AG & Co. KGaA, Duesseldorf (DE)

(21) Appl. No.: 16/318,082

(22) PCT Filed: Jul. 11, 2017
(86) PCT No.: PCT/EP2017/067340

§ 371 Date: Jan. 15, 2019

(30) Foreign Application Priority Data
Jul. 15, 2016 (DE) 10 2016 212 976.7
Jun. 12, 2017 (DE) 10 2017 209 863.5

(51) Int. Cl. D06F 34/18; G06K 9/20; G06T 7/00; G01N 21/94; D06H 3/08

(52) U.S. Cl. CPC D06F 34/18; G06K 9/2027; G06T 7/0004; G01N 21/94; D06F 2103/06; G06T 2207/30124; G06T 2207/10048; G01N 2021/945; D06H 3/08

(57) ABSTRACT

A method for determining a cleaning strategy for a soiled textile is provided. The method includes obtaining intensity information representative of a spectral image resulting from soiling of a textile. Further, the method includes determining at least one output variable that is dependent on the composition of the soiling on the basis of the intensity information. Also, the method includes outputting or triggering the output of the at least one output variable. Also provided are corresponding devices for carrying out such a method.

### CROSS-REFERENCE TO RELATED APPLICATION

This application is a U.S. National-Stage entry under 35 U.S.C. § 371 based on International Application No. PCT/EP2017/067340, filed Jul. 11, 2017 which was published under PCT Article 21(2), and which claims priority to German Application No. 10 2017 209 863.5, filed Jun. 12, 2017, and which claims priority to German Application No. 10 2016 212 976.7, filed Jul. 15, 2016, which are all hereby incorporated in their entirety by reference.

### TECHNICAL FIELD

The present disclosure relates to methods and devices for determining a cleaning strategy by employing at least one output variable, more particularly, by employing an output variable determined from a spectral image of soiling on a textile.

### BACKGROUND

Soiling on textiles, such as items of clothing, curtains or bedding, is often difficult to identify. Soiling may not only impact the esthetics of the textiles, but may also constitute a hygiene-related problem for the user of the textile.

Much soiling can be easily perceived by the naked eye, but the composition or origin of the soiling is often unclear to the user of the textile. In some cases, the user is, for example, not aware that the textile has even become soiled following a mishap. The soiling then becomes apparent to the user only at a later date, at which point the cause and the composition of the soiling is not clear to the user. Soiling having different compositions may appear very similar to the naked eye; for example, it may in particular no longer be possible to differentiate between blood stains and tomato stains with the naked eye after a certain period of time.

In this case, it is desirable for the user to obtain an indication of the composition of the soiling. In particular, this allows hygiene-related problems with the textiles to be identified or ruled out. In addition, in most cases it is of interest to remove the soiling again by employing a cleaning process. Such cleaning processes may be made considerably easier, or may even be made possible in the first place, by indications of the composition of the soiling.

### BRIEF SUMMARY

In certain embodiments, a method for determining a cleaning strategy for a soiled textile is provided. The method includes obtaining intensity information representative of a spectral image resulting from soiling of a textile. Further, the method includes determining at least one output variable that is dependent on the composition of the soiling on the basis of the intensity information. Also, the method includes outputting or triggering the output of the at least one output variable. In other embodiments, a device or devices for carrying out such a method is provided.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

Against the background, the problem addressed by the present disclosure is thus to at least partially reduce or prevent the above-described problems, i.e., to determine and provide indications of the composition of soiling on textiles. In certain embodiments, the proposed methods and devices are used in a domestic setting, in particular in a user-friendly manner.

According to a first aspect of the present disclosure, a method is described which is carried out by one or more devices, the method comprising: obtaining intensity information that is representative of a spectral image resulting from soiling of a textile; determining at least one output variable that is dependent on the composition of the soiling from the intensity information; and outputting or triggering the output of the at least one output variable.

According to a second aspect of the present disclosure, a device is described that is designed, or comprises corresponding means, for carrying out and/or controlling a method according to the first aspect. Devices for the method according to the first aspect are, or comprise, in particular one or more devices according to the second aspect.

In an exemplary embodiment, a spectral image results from radiation, for example electromagnetic radiation, being reflected and emitted by the soiling. The resulting spectral image, which comprises the intensity and energy distribution of the resulting radiation, is directly influenced by the composition of the soiling. The composition of the soiling of the textile can be understood to mean the chemical composition and, thus, the type of soiling, the degree of soiling or amount of soiling, and/or the spatial extension or distribution of the soiling, such as the shape and/or thickness of the soiling.

Soiling is in particular understood to mean an accumulation of foreign matter on a material of a textile or a discoloration of the surface of the textile, in particular, in the form of a stain, some dirt, or marks. For example, particles such as dust, traces of liquids, dyes or fatty residues may be found on the surface. Furthermore, non-fixed textile dyes could also have been introduced into the material of the textile, and the non-fixed textile dyes may dissolve out of the material during a cleaning process such as washing, for example. Soiling may also be understood to mean such textile components, for instance textile dyes, that have dissolved out.

A textile is understood in particular to include items of clothing, curtains, or bedding. Items of clothing and bedding, for example, include shirts, t-shirts, dresses, jackets, sweaters, pants, blankets, covers, and covers for bedding. The textiles may include various materials, for example natural fibers, chemical fibers, or even other materials such as leather.

The intensity information obtained according to the first aspect is representative of a spectral image resulting from soiling of a textile. In this case, the obtained intensity information need only be representative of at least part of the spectral image. The intensity information contains, in particular, at least one value that is representative of the intensity of the spectral image within an energy range. Using a value that is representative of the intensity of the spectral image within an energy range, for example a monochrome intensity or an intensity integrated over an energy range can be detected. Using a plurality of values that are each representative of the intensity in different energy ranges, a spectral intensity distribution with energy resolution can be obtained. Intensity information of this kind can be gained by a physical measurement.

Since the composition of the soiling influences the resulting spectral image, the intensity information obtained is also determined by the composition of the soiling. An output variable that is dependent on the composition of the soiling can thus be determined from the intensity information.

The at least one output variable may in particular be one or more values that are representative of the chemical composition of the soiling, of the degree of soiling, and/or of the spatial distribution of the soiling. For example, the at least one output variable includes at least one value for the presence and/or the concentration of a chemical element or a chemical compound, the amount of the soiling, the shape of the soiling, the thickness of the soiling, the color of the soiling, and/or the surface area of the soiling. The at least one output variable can also be determined by a classification of the intensity information.

In particular, a further indication of the composition of the soiling can be achieved from the spatial distribution or shape of the soiling. The intensity information may in particular be characteristic of the viscosity, capillarity, and/or the surface tension of the composition of the soiling. In particular, the intensity information may be characteristic of the age of the soiling. For example, fresh or older soiling may require different treatments.

The intensity information may be indicative of one or more colors of the soiling. For example, the intensity information indicates an average color, a color distribution, and/or a measure of the homogeneity of the color distribution. For example, the intensity information contains values in a color space such as an RGB color space and/or an L*a*b* color space. In particular, a color reference is used to determine the output variable, for example, a color chart which is recorded with the intensity information. The determination of the output variable can include white balancing, for example, on the basis of a reference such as a grey chart which is recorded with the intensity information. The determination of the intensity information so as to be indicative of the color of the soling may in particular comprise aspects of the color determination method described in WO2016/126470 A1, the subject matter of WO2016/126470 A1 being incorporated in its entirety by reference in the disclosure of the present application.

In particular, the intensity information contains a measure of the shine of the soiling, which is exemplified, for example, by the reflection of the surface of the soiling, in particular by the diffuse reflection of the surface. For example, the intensity information includes an angular dependence of the reflectivity of the surface of the soiling. In particular, the intensity information comprises a measure of the shine of the soiling at a plurality of location on the surface, in particular, at clean and soiled locations of the textile.

By outputting or triggering the output of the at least one output variable, the user can thus be provided with information regarding the composition of the soiling of the textile that advantageously contributes to identifying the soiling. The user may, for example, be provided with information regarding the chemical composition or the presence of individual elements or compounds of the composition of the soiling. In particular, by employing classification, further information can be provided by employing the at least one output variable, for example, whether the soiling contains any particular organic or inorganic components, such as dyes or lipids, and potentially the origin of the soiling. For example, the at least one output variable can give the user information as to whether the soiling possibly poses a hygiene-related issue.

The method according to the first aspect and the device according to the second aspect therefore, in particular, make it easier for the user to identify the composition or the origin of the soiling. If, for example, soiling cannot be identified with the naked eye, at least one output variable that is dependent on the composition of the soiling can be determined using the method and the device. The output variable can, for example, allow the user to differentiate between different compositions of soiling that have the same appearance to the naked eye.

It is conceivable for substances that have dissolved out of the material of the textile, for example, non-fixed textile dyes, to be detected as soiling by employing the at least one output variable. In one embodiment of the method according to the first aspect, the intensity information is however at least partially representative of a spectral image resulting from an illuminated surface of the soiling on a textile.

When the soiling is illuminated, for instance using radiation, such as electromagnetic radiation, a spectral image results from reflection and emission on or by the surface of the soiling. The soiling can be illuminated by employing the radiation spectrum of the sun, including natural light, or by employing an artificial radiation spectrum, for example, the spectrum of a thermal or non-thermal radiator such as incandescent lamps, fluorescent tubes, or LEDs. Excitation via monochrome radiation is also conceivable.

Usually, it should be possible to remove the soiling again by employing a cleaning process. In one embodiment of the method according to the first aspect, the at least one output variable comprises at least one parameter of a cleaning strategy of the textile. The user can thus be given a recommendation on a cleaning process that is optimal for the present soiling. The user can also be provided with various equivalent alternatives for possible parameters of a cleaning strategy. For example, the method comprises providing a plurality of parameters of a cleaning strategy, it being possible for the user to make a particular selection by retrieving preferences, for example. For example, the user may also indicate the cause of the soiling for selection, for example, whether it is soiling from food or from an outdoor activity (such as grass- or mud-based soiling). This also allows possible causes to be suggested to the user, it being possible for the user to select one or more of the options.

For soiling, the parameters of the cleaning strategy can be determined using the intensity information, which is dependent on the composition of the soiling. Here, the at least one parameter of the cleaning strategy can be determined indirectly from another output variable. For example, an output variable representative of the composition of the soiling may first be identified, and at least one parameter of the cleaning strategy may be determined from said output variable representative of the composition of the soiling. At least one parameter can also be determined directly from the intensity information, for example, by employing a classification using stored intensity information and cleaning strategies assigned to the classes.

In particular, if a user of the textile cannot identify the soiling with the naked eye and it is therefore unclear how to remove the soiling again, a recommendation on an optimal cleaning strategy can be provided using the method according to the first aspect and the device according to the second aspect. For example, it may be unclear to the user whether the soiling contains lipids or certain dyes which cannot be reliably removed using cleaning strategies that are usually applied. By employing the cleaning strategy that is determined as part of the method and is dependent on the composition of the soiling, a recommendation on a cleaning strategy adapted to the specific composition can be provided by identifying corresponding constituents of the soiling. As a result, the removal of the soiling can be significantly simplified and can be made much more reliable.

It is likewise conceivable for substances that have dissolved out of the material of the textile, for example non-fixed textile dyes, to be detected as soiling by employing the at least one output variable. This takes place in particular while the cleaning strategy is being carried out, such that the user is provided with a conclusion on the efficacy of the cleaning strategy. For example, the user can identify whether an excessively large quantity of textile dyes dissolves out of the material of the textile, which prompts the user to modify the cleaning strategy and optionally render it gentler with respect to the textile dye. Equally, decolorization of a textile may be intended and a conclusion may be drawn on the degree of decolorization brought about by a cleaning strategy by employing the at least one output variable.

In particular, the at least one parameter of the cleaning strategy constitutes a type of cleaning agent, an amount of cleaning agent, a cleaning temperature, a type of cleaning device, settings of a cleaning device, or combinations thereof.

Cleaning agents are used in a domestic setting for cleaning different objects. For example, a cleaning agent, e.g., a washing agent, is used in washing machines to clean textiles. A cleaning agent is, however, also intended to mean cleaning agent aids or cleaning additives, such as a bleaching additive, a softener, or starch. A cleaning agent may also be a liquid, a disperse system, for example a gel or foam, or a solid, in particular a tablet, powder, or granulate.

A cleaning agent may for example comprise one or more components from the group of components including surfactants, alkalis, builders, graying inhibitors, optical brighteners, enzymes, bleaching agents, soil-release polymers, fillers, plasticizers, fragrances, dyes, care substances, acids, starch, isomalt, sugar, cellulose, cellulose derivatives, carboxymethylcellulose, polyetherimide, silicone derivatives, and/or polymethylimines.

A cleaning agent may also comprise one or more other components. These components include, but are not limited to, the group including bleach activators, complexing agents, builders, electrolytes, non-aqueous solvents, pH adjusters, perfume carriers, fluorescing agents, hydrotropic substances, silicone oils, bentonites, anti-redeposition agents, shrinkage-preventing agents, crease-preventing agents, dye transfer inhibitors, anti-microbial active ingredients, germicides, fungicides, antioxidants, preservatives, corrosion inhibitors, antistatic agents, bittering agents, ironing aids, repellents and impregnating agents, anti-swelling and anti-slip agents, and/or UV absorbers.

The at least one parameter of the cleaning strategy can represent the type of cleaning agent and therefore can be indicative of the composition of the cleaning agent. If, for example, a certain proportion of dye is contained in the composition of the soiling, it may be recommended to the user that they should use certain bleaching additives. If, for example, there are certain levels of lipids in the composition of the soiling, the use of specific surfactants and/or lipases may be contained in the recommended cleaning strategy.

The at least one parameter can represent the amount of cleaning agent and in particular can indicate an absolute amount of the cleaning agent. Equally, a relative amount of the cleaning agent can be indicated by the at least one parameter, for example based on the mass of the textiles to be cleaned or a liquor ratio, or an amount of cleaning agent based on a water volume to be used for the cleaning. By employing the intensity information which is dependent on the composition of the soiling, a type of cleaning agent and/or an amount of cleaning agent can be determined which ensures optimal removal of the soiling.

Using a parameter representative of the cleaning temperature, a temperature that is optimal for the particular composition of the soiling can be specified for removing the soiling, in particular in combination with a type of cleaning agent. Here, the cleaning temperature can be high enough to ensure that the soiling is removed as fully as possible and can also kept low enough in order to save energy and to care for the textile.

As a treatment of the textile, the textile may for example be dyed with respect to the soiling or may undergo a gentle treatment. For example, a dyeing recommendation can be determined on the basis of the intensity information, the textile being given a refresh or a change in color by dyeing according to the cleaning strategy.

The parameter of the cleaning strategy may also be indicative of a pretreatment and/or finishing treatment of the textile. For example, the at least one parameter indicates the temperature and/or a program for ironing and/or drying the textile, for example for an ironing device and/or a dryer.

A cleaning device is in particular understood to be a washing machine, in particular an automatic domestic washing machine.

The washing machine may have various designs. A distinction is made between top-loading washing machines, in which the loading opening is on the top, and front-loading washing machines, in which a porthole on the front serves as the loading opening. An advantage of top-loading washing machines is that it is easier to construct the door seal and the drum can be supported on two sides by roller bearings, and a top-loading washing machine can also be positioned in very small spaces where there is not enough space to open a front door. By contrast, a front-loading washing machine provides space on top for e.g. a tumble dryer or for a worktop, and is therefore sometimes built into a kitchen unit instead of a floor cupboard.

American top-loading washing machines always have a rotating drum and mixing elements (agitators or discs), with the mixing elements being able to move in or counter to the rotational direction of the drum. The machines may comprise a suds circulator and injectors for the suds. In principle, a distinction is made between deep-fill and HE top-loading washing machines. Deep-fill top-loading washing machines operate at a specified water level, and therefore do not use any load detection. HE washing machines generally have load detection and control the amounts of water in accordance therewith. Generally, the machines do not have an integrated heater, but instead are connected to a cold and hot water feed.

In the context of the present disclosure, one parameter of the cleaning strategy can specify a specific type of such a cleaning device. It is also conceivable for the parameter to specify cleaning strategies that are intended to be carried out manually at least in part, such as a handwash. The at least one parameter may also include settings for a cleaning device, for example a program for an automatic domestic washing machine or a sequence of such programs.

As a result, the at least one parameter of the cleaning strategy can make it considerably easier for the user to remove the soiling. In particular for soiling which cannot be identified with the naked eye, a cleaning strategy that is optimal both in terms of the cleaning but also in terms of energy consumption and caring for the material of the textile can be recommended using the method. For example, the recommendation on the type of cleaning agent and the settings for the cleaning device contains information as to whether the intensity information indicates a certain level of lipids in the soiling and therefore that corresponding degreasing components should be contained in the cleaning agent, or as to whether certain dyes are present in the soiling that can be tackled in a targeted manner by a specific type of cleaning agent and settings of the cleaning device.

The at least one parameter may include a recommendation on pretreatment of the textile. Pretreatment of this type for example involves manually or automatically applying a cleaning agent to the soiling, in particular for a specified contact time, the duration of which can also serve as a parameter of the cleaning strategy. The textile can then be cleaned in a cleaning device, for example an automatic domestic washing machine.

In particular, the method further comprises carrying out the cleaning strategy by employing a cleaning device.

In this process, the intensity information can be obtained before, during and/or after the cleaning strategy for the textile is carried out. By obtaining said information before the cleaning, the user can for example be given a recommendation on the cleaning strategy to be used before a cleaning treatment that is to be carried out.

If the intensity information is obtained during the cleaning, the cleaning can for example be carried out dynamically, i.e. a cleaning device can be adjusted during the cleaning to the at least one output variable that has just been determined, in particular by the output variable being continuously determined. For example, a washing machine adjusts the temperature or the amount of cleaning agent during the washing program according to the determined output variable. Here, the intensity information can be obtained in particular from textile components, such as textile dyes, that have dissolved out of the textile.

When obtaining the intensity information after cleaning, the result or the efficacy of a cleaning strategy can be recorded and checked, for example. The at least one output variable can be output to the user on a display, or a corresponding output can be triggered. The user can then carry out the cleaning strategy. Alternatively, or additionally, in one embodiment of the method, the at least one output variable can be output to a cleaning device. For example, the at least one output variable may represent at least one parameter of a cleaning strategy that is output to the cleaning device, such that the cleaning device for example adopts the corresponding cleaning strategy as a preset and the user merely has to start the cleaning device. It is equally conceivable for the cleaning device to automatically carry out the cleaning strategy when the at least one output variable is output. The cleaning device may for example have a dosing device for cleaning agent, in order to automatically provide the type of cleaning agent and the amount of cleaning agent in accordance with the recommended cleaning strategy. This makes the method more user-friendly as a result.

In one embodiment of the method, the determination of the at least one output variable includes comparing the intensity information with comparative values. Corresponding comparative values can be stored in a database. The intensity information may be subject to a classification, with the at least one output variable being obtained or influenced by a result of the classification. In particular, the intensity information undergoes cluster recognition. A classification may for example be based on a comparison of the intensity information with a database of known intensity information.

The comparative values or a database provided for this purpose may in particular contain intensity information for typical soiling occurring in the fields of application of textiles. For example, in a domestic setting, intensity information for typical soiling such as different food residues, traces of beverages, grass or dyes can be drawn upon. In particular, comparative values for soiling of different ages, such as fresh or dried-in soiling, are of interest. The comparative values may include at least one value for the intensity in a particular energy range of a spectral image and/or continuous values for at least one energy interval of a spectral image. Furthermore, particular output variables may be assigned to the corresponding comparative values, for example at least one parameter of a cleaning strategy for removing the soiling.

The determination of the output variable may include one or more steps of feature extraction and/or feature matching from the intensity information. For example, methods are used which correspond to those of the evaluation of biometric photos.

In one embodiment of the method, the method further comprises determining the intensity information in particular by employing an optical sensor. Here, an optical sensor means sensors which can determine an intensity of incident radiation, in particular electromagnetic radiation in the visible range and beyond. In particular, the optical sensor is designed to provide an energy resolution and/or spatial resolution of the intensity information. The optical sensor may comprise an image sensor, in particular a digital image sensor. In order to determine the intensity of the radiation, in particular at least one semiconductor element, diodes, CCD elements, for example a Bayer sensor, or CMOS elements, for example a sensor of the Foveon X3 type, can be used. The optical sensor may include optical filters and in particular a spectrometer. Other optical elements such as lenses and/or filters, for example an external monochromator, may also be provided.

According to one embodiment, the intensity information is representative of spectral components of a spectral image. The spectral components may be within the visible range. If, according to a further embodiment of the method, the intensity information is representative of spectral components of a spectral image, with at least one of the spectral components lying outside the visible energy range, the composition of the soiling can be determined with increased accuracy. By taking into account non-visible spectral components, it is also possible to identify different types of soiling, despite these being indistinguishable to the naked eye. In order to determine spectral components of the spectral image, there can in particular be a comparison with a sensitivity spectrum of the optical sensor, for example on the basis of predetermined settings or by comparison with a reference.

In particular, the intensity information is representative of spectral components of a spectral image in the ultraviolet energy range. Spectral components in the infrared energy range can also be taken into account. The intensity information is in particular representative of spectral components of a spectral image from the infrared energy range as far as the ultraviolet energy range, for example at least for spectral components of a spectral image having wavelengths of from about 1400 nm to about 315 nm, preferably for wavelengths of from about 3000 nm to about 280 nm, more preferably for wavelengths of from about 5000 nm to about 200 nm. The intensity information is in particular representative of spectral components of a spectral image in the (near) infrared energy range, for example for wavelengths of from about 700 nm to about 2400 nm, in particular from about 780 nm to about 2000 nm, in particular up to about 1450 nm.

The use of monochrome sensors without color resolution is also conceivable. Likewise, sensors can be used which are limited to specific wavelength ranges. For example, the optical sensor can be based on at least one photodiode and/or at least one LED element. Individual elements or arrays of elements, such as photodiodes or photosensitive components such as LEDs, may be used. It can be advantageous to optimize the size of the individual sensor elements, for example the individual photodiodes, in terms of dynamics, resolution and/or sensitivity.

In one embodiment of the method, the method further comprises: referencing the determination of the intensity information. For example, in order to determine spectral components of the spectral image, there can in particular be a comparison with a sensitivity spectrum, for example on the basis of predetermined settings or by comparison with a reference. The reference may in particular be a chart, for example in the form of a color chart, gray chart and/or a size scale, which can be placed on or next to the soiling. A reference can also be mounted in and/or on a cleaning device. For example, a surface inside the cleaning device, such as the surface of a cleaning container, is provided with a reference. The reference may also be part of an outer packaging of a means for carrying out a washing, cleaning, care or dyeing process, for example in the form of an imprint, a removable part of the packaging or as digital information, for example in the form of an electronic label. Referencing may also take place by employing the textile. For example, the intensity information is indicative of both the soiling and the textile, i.e., of soiled and clean points on the textile. By employing a comparison, for example a difference between the intensity information regarding the soiling and the clean textile, the composition of the soiling can be further determined.

Furthermore, a radiation source can be provided, for example a light source such as an illumination means and/or a flash, which is coordinated in particular with the optical sensor and is used to illuminate the surface of the soiling. A radiation source of this kind can be combined with the optical sensor in one modular unit.

If the method comprises subjecting the soiling to radiation, for example illuminating the soiling, a determination of the intensity information can be based on a defined excitation. For example, the soiling is subjected to or illuminated by radiation by employing a light source, the radiation used having a specific intensity and/or specific spectral distribution. By such illumination of at least part of the soiling, sufficient illumination is ensured irrespective of the external conditions. This makes it possible to determine the intensity information even in poor external conditions, such as low daylight in a dark room, or in any case to improve the quality of the determination.

Illumination is understood to mean that light is generated using an artificial light source such that in particular (better) visualization of the soiling of the textile can occur. The illumination takes place in particular by radiation which lies at least in part in the visible range of the electromagnetic spectrum, for example with a radiation of which the wavelength covers at least part of the wavelength range of from about 380 nm to about 780 nm. The excitation may also comprise components in the (near) infrared range and/or in the ultraviolet energy range.

LEDs are used for illumination, for example. LEDs can cover a well-defined frequency range in this respect. LEDs having different color temperatures can be used individually or in combination, for example with red, green, blue and/or white LEDs.

The wavelength range can be further coordinated specifically with the determination of the intensity information. For example, an optical sensor comprising a CMOS element is used which has a sensitivity maximum in the near-infrared range (NIR). In this case, illumination using radiation in the NIR range is advantageous. The NIR range is understood to mean a wavelength range of the electromagnetic spectrum of at least about 650 nm, in particular up to a maximum of about 2000 nm, in particular of at least about 750 nm to a maximum of about 1400 nm.

The duration of the excitation can be varied in this case. In particular, the length of time may be relatively short, i.e. less than a second, with a flash being used, for example. The duration of the excitation can also be less than about 0.1 seconds, in particular less than about 0.01 seconds. A short excitation or a flash can be used alone or combined with another illumination means. For example, a flash is used in combination with a continuously operating illumination means, with the flash and the illumination means being integrated in a combined illumination unit. It is also possible to temporally modulate the luminous intensity.

The illumination means and the optical sensor can also use the same elements, at least in part, which allows significant cost advantages for the production of the device, especially when using LEDs. If the illumination means and the optical sensor are provided by employing at least partially identical elements, it is easier to coordinate the excitation and detection on specific wavelength ranges. For example, LEDS can both emit and detect light. The soiling can be positioned between an illumination means comprising at least one transmitter LED and an optical sensor comprising at least one receiver LED. If the transmitter LED and the receiver LED are identical, transmission or attenuation of the radiation by the soiling can be determined in a particularly simple and direct manner An arrangement of the transmitter LED and receiver LED can also be provided in a reflection or emission measurement.

In one embodiment, intensity information is obtained using three-dimensional spatial resolution. Using three-dimensional spatial resolution, the accuracy of the determination of the soiling can be further increased. It is conceivable to use a plurality of images from different perspectives by employing the same optical sensor or the same sensor arrangement. Likewise, optical elements which are specially designed for three-dimensional resolution, such as add-on lenses or objectives, may be provided, or a 3D camera may be used. Additional optical elements, for example add-on lenses or objectives, can also be arranged on conventional, substantially two-dimensional optical sensors, for example digital cameras or cameras integrated in mobile devices. Therefore, existing devices can also be retrofitted for three-dimensional resolution. With the three-dimensional resolution, the spatial extension of the soiling can be determined in more detail and thus, in terms of the composition of the soiling, more comprehensive and accurate intensity information can be obtained.

In particular, the intensity information includes one or more parameters of size information, for example of a spatial extension or of the volume of the soiling. In particular, the thickness of the soiling can also be determined. In particular, the size information is determined in conjunction with a reference, such as a size scale.

In particular, the intensity information includes a measure of the roughness of the surface of the soiling, for example in conjunction with three-dimensional spatial resolution. The measure of the roughness can include, for example, the average roughness R_{A}, the average surface roughness R_{z} and/or the maximum surface roughness Rₘₐₓ.

In order to determine the intensity information in particular by employing an optical sensor element, one or more references can also be used. The references may be detected before, after and/or simultaneously with the intensity information by employing the sensor. For example, a calibration chart is used which includes color references and/or size references. Thus, for example, the intensity information with respect to the color and the dimensions, in particular in the case of three-dimensional spatial resolution, can be determined more accurately by detecting the calibration chart.

In a particularly simple embodiment, the at least one optical sensor element comprises at least one camera-like element and provides image information. Accordingly, digital cameras or cameras integrated in mobile devices can be used for the method or serve as at least one device for carrying out the method. In this case, add-ons for three-dimensional spatial resolution can be used on the camera-like element.

In one embodiment, the image information comprises at least two individual images of the soiling. In this case, the individual images can reproduce a temporal sequence, for example one or more film sequences, or even a variation of the position and perspective of the camera-like element. As a result, the accuracy of the intensity information can be further increased. In particular, as already described above, three-dimensional spatial resolution can be achieved by employing a plurality of individual images. The soiling can also be detected from different sides, for example from the front, back, outside and/or inside.

In a further embodiment of the method, the method further comprises: determining a soiling profile based at least in part on the output variable, in particular based on a plurality of determined output variables, the determination of the at least one output variable being based at least in part on the soiling profile.

By employing the at least one output variable, a soiling profile can thus be produced which is adjusted to the particular composition of the soiling. In particular, a plurality of output variables, in the sense of a history of determined output variables, can feed into a soiling profile, such that future determinations can be based at least in part on the soiling profile. Therefore, the determination of the at least one output variable can be designed to be adaptive, and is more precisely adjusted to the respective requirements by employing the soiling profile. The output variable can be determined more precisely in particular in terms of its dependence on the chemical composition of the soiling.

For example, a soiling profile can be produced with regard to frequently occurring compositions of soiling. For outputting at least one parameter of a cleaning strategy, in particular the type of cleaning agent and the type of cleaning device can also be taken into account in a soiling profile.

It is also conceivable for information on the efficacy of the cleaning strategy to be incorporated in the soiling profile. For example, intensity information can be determined again after a cleaning process in order to determine the efficacy of the cleaning strategy. In this way, future cleaning strategies can be optimized by employing the soiling profile.

Equally, the user can evaluate the at least one output variable after the cleaning, for example evaluate the efficacy of the cleaning strategy that is adopted in the soiling profile. Therefore, the determination of the output variable, in particular the cleaning strategy, can be personalized.

It is also possible for the repeated obtaining and/or determination of the intensity information or of the at least one output variable to be used for machine learning. This means that the soiling profile can for example be determined at least in part based on machine learning. Machine learning is understood to mean that an artificial system (for example a device according to the second aspect or a system according to the third aspect) learns from examples, and can generalize said examples following the learning phase. This mean that it does not simply memorize the examples, but rather it recognizes patterns and regularities in the learning data. Various approaches can be taken for this purpose. For example, supervised learning, semi-supervised learning, unsupervised learning, reinforcement learning and/or active learning can be used, in particular in conjunction with deep learning methods. Supervised learning can for example be carried out by employing an artificial neural network (such as a recurrent neural network) or by employing a support vector machine. In addition, unsupervised learning can also be carried out for example by employing an artificial neural network (for example an autoencoder). In particular the repeatedly obtained and/or determined intensity information or the at least one output variable are then used as learning data, for example.

Alternatively, or additionally, it is conceivable for the obtained and/or determined intensity information or at least one output variable to be associated with other information, for example with the number and/or the ages of the people in a household in order to produce a personalized soiling profile, or for example with the seasons in order to produce a seasonal soiling profile.

In particular, the soiling profile can also be influenced by other soiling profiles of other people. For example, preferences and/or comparative values can be compared with those of other users or introduced as a suggestion. The evaluation of the intensity information can be further optimized as part of such crowdsourcing.

These measures allow the reliability of the determination of the at least one output variable, and in particular of the cleaning strategy, to be increased.

In another embodiment of the method, at least one of the devices for carrying out the method is a mobile device. In particular, communication may be implemented by employing a communication system between a mobile device, for example a smartphone, laptop, tablet, wearable, smartwatch, smart pen or a camera, and at least one other device, for example a cleaning device and/or an optical sensor. One of the devices may also be a cleaning robot. According to one embodiment, the device according to the second aspect comprises a communication interface. For example, the communication interface is designed for wired or wireless communication. For example, the communication interface is a network interface. The communication interface is preferably designed to communicate with a communication system. Examples of a communication system are a local network (LAN), a wide area network (WAN), a wireless network (for example in accordance with the IEEE-802.11 standard, the Bluetooth (LE) standard and/or the NFC standard), a wired network, a mobile network, a telephone network, and/or the Internet. A communication system may include communication with an external computer, for example over an Internet connection.

In particular, an optical sensor for determining the intensity information is provided and integrated in a mobile device. This makes it easier for the user to determine the intensity information. It is also conceivable for an optical sensor to be provided in a cleaning device and/or for a mobile device to be used to display the at least one output variable.

In another embodiment of the method, the intensity information is representative of a hyperspectral image. Intensity information representative of a hyperspectral image is understood in particular to mean that the intensity information has, as an intensity distribution, intensity values in a plurality of channels for different energy intervals, at least two of the energy intervals adjoining or overlapping one another. In particular, a hyperspectral image can be distinguished from a multispectral image in that, while a multispectral image also has intensity values in a plurality of channels for different energy intervals, the energy intervals are however spaced apart, i.e. intensities of individual, distinct energies are reproduced in a multispectral image. In contrast, in a hyperspectral image, in particular “adjacent” intensity values are reproduced by at least two of the energy intervals adjoining or overlapping one another. A hyperspectral image can thus at least partially reproduce a continuous spectrum. Intensity information representative of a hyperspectral image is in particular advantageous in that information which is not visible to the naked eye and is indicative of the composition of the soiling can also be detected.

The intensity information can comprise values in at least about 20 channels, each channel representing an intensity for one energy interval. If values of the intensity information are provided in at least about 20 channels, the resolution of the spectral image and thus also the accuracy of the determination of the output variable can be improved. In particular, the intensity information comprises at least about 20 channels up to about 250 channels, thus achieving a more accurate dependence of the output variable on the composition of the soiling. With at least about 20 channels, in intensity information representative of a spectral image, in particular of a hyperspectral image, energy intervals can be represented which cannot be resolved by the human eye, which has only three channels in the visible range.

If, according to a further embodiment of the method, the intensity information is representative of spectral components of a spectral image, with at least one of the spectral components lying outside the visible energy range, the composition of the soiling can feed into the determination of the output variable with increased accuracy. By taking into account non-visible spectral components, it is also possible to identify different compositions of soiling, despite the soiling being indistinguishable to the naked eye.

In particular, the intensity information is representative of spectral components of a spectral image in the ultraviolet energy range. Spectral components in the infrared energy range can also be taken into account. The intensity information is in particular representative of spectral components of a spectral image from the infrared energy range as far as the ultraviolet energy range, for example at least for spectral components of a spectral image having wavelengths of from about 1400 nm to about 315 nm, preferably for wavelengths of from about 3000 nm to about 280 nm, more preferably for wavelengths of from about 5000 nm to about 200 nm.

The intensity information can be representative of an individual image point of the spectral image. However, in one embodiment of the method, the intensity information is in particular representative of spatially resolved components of a spectral image. A spatially resolved intensity pattern comprises the information regarding the intensity of the radiation at at least two positions in space. The spatially resolved intensity pattern can be measured for example by a movable optical sensor, the position of the optical sensor being varied and an intensity being measured at each position. However, it is preferable to use an optical sensor having a plurality of spaced-apart sensor elements, for example pixels, it being possible to obtain spatially resolved intensity information by employing the intensity information in the different pixels.

A one-dimensional, for example linear, resolution is conceivable in this case. In one embodiment of the method, however, a two-dimensional spatial resolution is carried out. In particular, the spatial resolution is carried out by employing a planar arrangement of sensor elements or at least one sensor array, for example pixels.

In one embodiment of the method and/or of the device, the determination of the intensity information that is representative of spatially resolved components of a spectral image can be carried out by employing an integrated camera of a mobile device, in particular by employing a hyperspectral camera which is designed to determine intensity information that is representative of a hyperspectral image.

In an alternative or additional embodiment, the intensity information can be determined by employing a sensor, the sensor being arranged on a cleaning device. For example, the sensor is arranged at least in part on the outer housing of a cleaning device and outside a cleaning container in which cleaning can be carried out. This means that the user always has access to the sensor even if the cleaning device is in operation or is switched off. Therefore, a method according to the first aspect can be carried out at any time. In this case, the sensor can be fastened to the cleaning device, for example using fastening means such as a screw and/or adhesive. Equally, the sensor can also be arranged so as to be freely positionable on the cleaning device using positioning means, for example using a magnetic fixture. A mobile device such as a smart pen can be provided, and this is detachably arranged on and/or in the treatment device and can communicate with the treatment device for example via a cable and/or by radio. A mobile device of this kind may include one or more sensors.

In addition, the sensor can be arranged inside the cleaning device at least in part, in particular in the region of a cleaning container of the cleaning device in which cleaning can be carried out. In particular, the sensor is arranged in a position accessible to the user in this case. Here too, the sensor can be fastened to the cleaning device, for example using fastening means, or can be freely positionable using positioning means. The sensor is for example arranged on an opening in the cleaning container, in particular on a door. In a washing machine, the sensor is for example arranged on the loading opening of the washing drum and/or on the seal of the loading opening.

The sensor may also be designed to be freely movable inside the cleaning container. In one embodiment, a determination device is provided, the determination device comprising: at least one sensor element for determining the intensity information and optionally at least one illumination means, the device being designed to provide the intensity information while a cleaning strategy is being carried out in a cleaning container of a cleaning device. For example, the determination device is designed to be arranged so as to be freely movable in a washing drum of a washing machine during a washing process. The determination device may have a shape corresponding to the cleaning treatment, and for example may have a rounded, in particular spherical, shape. The determination device may also have corresponding impermeability and mechanical resistance such that a washing solution and aggressive cleaning agents do not impair the functioning of the determination device. The determination device can therefore provide intensity information for the soiling during a cleaning process in order to monitor the cleaning strategy. The intensity information can be determined both for soiling on the surface of a textile and/or for soiling such as dissolved textile components such as textile dyes, for example by analyzing the washing solution. The intensity information can in this case be determined in transmission and/or reflection and emission.

In particular, at least one sensor that is located outside the cleaning container at least in part is combined with at least one sensor that is located within the cleaning device or cleaning container at least in part and is in particular freely movable. A plurality of sensors of the same type or different types may be provided. This means that the accuracy of the determination of the at least one output variable is improved since the sensors can provide intensity information corresponding to different positions. In particular, at least one of the sensors operates continuously, at least periodically, such that intensity information is obtained at different points in time and in particular continuously during a cleaning treatment.

Equally, at least one sensor may be arranged on a part of a cleaning agent packaging, and for example may be arranged so as to be integrated in a closure cap or arranged on a closure cap, in particular by being fitted thereon. This means that the sensor is movable freely and independently of a cleaning device and can be used by the user in a simple manner on soiling of a textile. The sensor can then also be used in conjunction with a plurality of different cleaning devices.

According to one embodiment of the method according to the first aspect, the method further comprises subjecting the intensity information to a processing algorithm.

This can result in improved differentiation of different compositions of the soiling of the textile. For example, the intensity information is subjected to a conversion algorithm. For example, the determined intensity information (for example one or more pieces of image information) can be converted from a first representation space into a second representation space, for example from a first color space to a second color space. Examples of color spaces are for instance an RGB color space or an L*a*b* color space. For example, the determined image information is converted from an RGB color space into an L*a*b* color space.

An RGB color space is understood to mean an additive color space which recreates color perceptions by the additive mixing of three primary colors (red, green and blue). An example of an L*a*b* color space is for example the CIELAB color space, which is standardized in EN ISO 11664-4 “Colorimetry—Part 4: CIE 1976 L*a*b* Colour space” (CIE 1976 color space). It is advantageous here for colors to be defined independently of the nature of the production or reproduction technique thereof, in the way that they are perceived by a normal observer in standard lighting conditions (device independence and perceptuality).

In order to determine the at least one output variable, color differences between pixels of image information can in particular be evaluated. For this purpose, in particular methods based on the color difference or color distance ΔE can be used. In particular, ΔE is calculated in the CIELAB color space. Likewise, the brightness in the intensity information can be used to determine the at least one output variable.

In particular, the determination of the output parameter includes a correlation of the intensity information. In particular, portions of the intensity information can be correlated with one another. In this process, portions that are representative of image information, representative of spectral components in the visible range having other energy ranges, in particular including the (near) infrared range, can be correlated with one another. For example, the shape of the soiling is determined by employing the image information and the composition of the soiling is determined by employing the spectral components, and these are compared.

According to the second aspect of the present disclosure, an alternative device is also described that comprises at least one processor and at least one memory comprising computer program code, the at least one memory and the computer program code being designed to carry out and/or control at least one method according to the first aspect using the at least one processor. A processor is for example intended to mean a control unit, a microprocessor, a microcontrol unit such as a microcontroller, a digital signal processor (DSP), an application-specific integrated circuit (ASIC) or a field programmable gate array (FPGA).

For example, an exemplary device further comprises means for storing information, such as a program memory and/or a main memory. For example, an exemplary device as contemplated herein further comprises means for respectively receiving and/or transmitting information over a network, such as a network interface. For example, exemplary devices as contemplated herein are and/or can be interconnected via one or more networks.

An exemplary device according to the second aspect for example is or comprises a data-processing system set up using software and/or hardware in order to execute the respective steps of an exemplary method according to the second aspect. Examples of a data-processing system are a computer, a desktop computer, a server, a thin client and/or a portable computer (mobile device), such as a laptop computer, a tablet computer, a wearable, a personal digital assistant or a smartphone.

Individual method steps of the method according to the first aspect (for example obtaining or determining intensity information, determining the at least one output variable and/or determining a soiling profile) can be carried out in this case using a sensor device which also has at least one sensor element. Likewise, individual method steps (for example obtaining or determining intensity information, determining the at least one output variable and/or determining a soiling profile) which do not necessarily have to be carried out by the sensor means, for example, may be implemented by another device which is communication with the device that has at least one sensor element, in particular via a communication system.

Other devices may be provided, for example a server and/or for example a part or component of a computer cloud, which provides data-processing resources dynamically for different users in a communication system. A computer cloud is in particular understood to mean a data-processing infrastructure in accordance with the definition from the National Institute for Standards and Technology (NIST) for the term “cloud computing”. One example of a computer cloud is a Microsoft Windows Azure platform.

According to the second aspect of the present disclosure, a computer program is also described that comprises program instructions that prompt a processor to execute and/or control a method according to the first aspect when the computer program is running on the processor. An exemplary program as contemplated herein may be stored in or on a computer-readable memory medium which contains one or more programs.

According to the second aspect of the present disclosure, a computer-readable memory medium is also described which contains a computer program according to the second aspect. A computer-readable memory medium may be designed e.g. as a magnetic, electrical, electromagnetic, optical and/or different kind of memory medium. A computer-readable memory medium of this kind is preferably a physical object (i.e. “tangible”); for example, it is designed as a data carrier device. Such a data carrier device is for example portable or permanently installed in a device. Examples of a data carrier device of this type are volatile or non-volatile memories with random access (RAM), such as NOR flash memories, or with sequential access, such as NAND flash memories, and/or memories with read-only access (ROM) or read/write access. Computer-readable is for example intended to mean that the memory medium can be read and/or written to by a computer or a data-processing system, for example by a processor.

According to a third aspect of the present disclosure, a system is also described that comprises a plurality of devices, in particular a mobile device and a cleaning device, which together carry out a method according to the first aspect.

An exemplary system according to the third aspect comprises an exemplary cleaning device and additionally another device, for example a mobile device or a server for carrying out an exemplary method according to the first aspect.

The exemplary embodiments of the present disclosure described above in this description are also intended to be understood to be disclosed in any combination with one another. In particular, exemplary embodiments are intended to be understood to be disclosed in relation to the different aspects.

In particular, by way of the preceding or following description of method steps according to preferred embodiments of a method, corresponding means for carrying out the method steps are also intended to be disclosed by preferred embodiments of a device. Likewise, the disclosure of employing a device for carrying out a method step is also intended to disclose the corresponding method step.

Further advantageous, exemplary embodiments of the present disclosure are found in the following detailed description of some exemplary embodiments of the present disclosure, in particular in conjunction with the drawings. The drawings are however only provided for illustrative purposes, and do not serve to define the scope of protection of the present disclosure. The drawings are not to scale and are merely intended to provide an example of the general concept of the present disclosure. In particular, features contained in the drawings are not in any way intended to be considered as necessary components of the present disclosure.

### BRIEF DESCRIPTION OF THE DRAWINGS

The present disclosure will hereinafter be described in conjunction with the following drawing figures, wherein like numerals denote like elements, and:

FIG. 1 is a flow diagram of one embodiment of a method;

FIGS. 2a, 2b, and 2c schematically show a spectral image and intensity information representative thereof;

FIG. 3 schematically shows one embodiment of a device;

FIG. 4 is a block diagram of one embodiment of a device; and

FIG. 5 shows different embodiments of a memory medium.

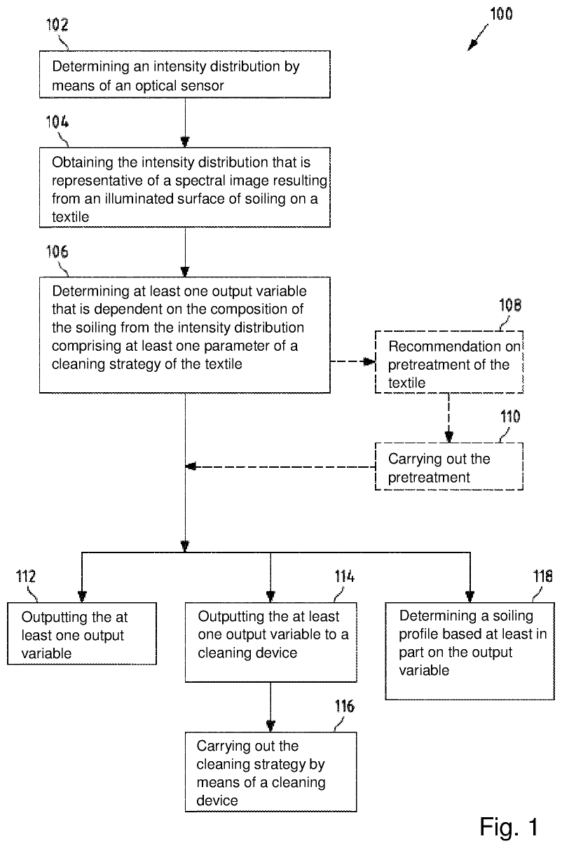

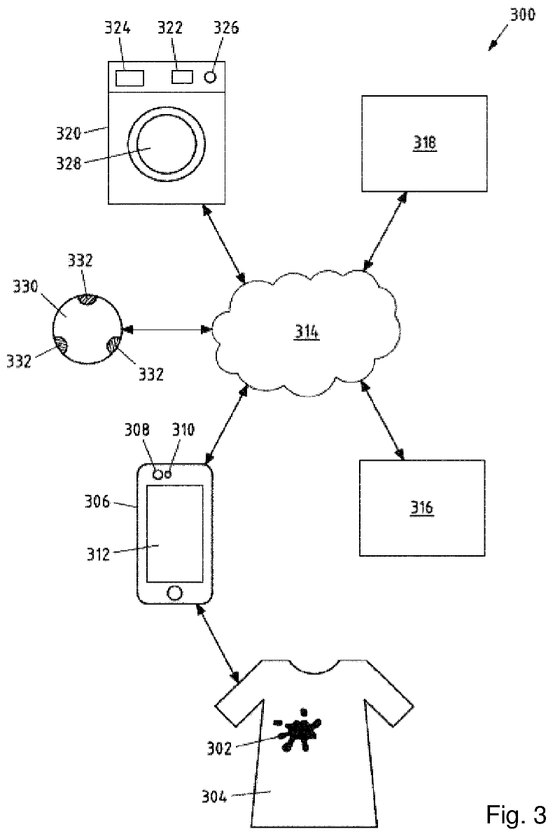

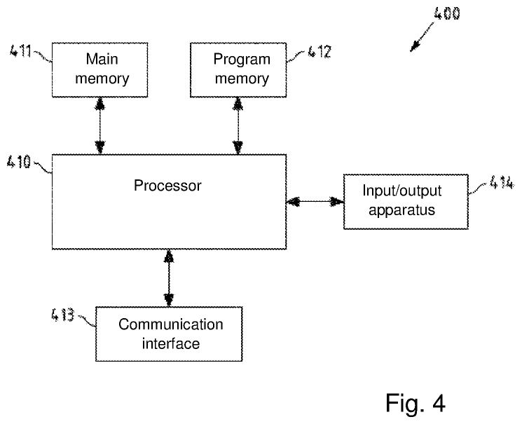

FIG. 1 is a flow diagram 100 of one embodiment of a method according to the first aspect, which is carried out by a device, such as one of the devices from FIGS. 3 and 4. In the action 102, intensity information in the form of an intensity distribution is determined by employing an optical sensor, the intensity distribution being representative of a spectral image resulting from an illuminated surface of soiling on a textile. The intensity distribution is in particular representative of a hyperspectral image and comprises intensity values in a plurality of channels for different energy intervals, at least two of the energy intervals adjoining or overlapping one another.

Said intensity distribution is obtained in the action 104. Since the intensity distribution is dependent on the chemical composition of the soiling on the textile, in action 106 at least one output variable that is dependent on the composition of the soiling can be determined from the intensity distribution. Here, at least one parameter of a cleaning strategy of the textile is determined on the basis of the chemical composition of the soiling, the cleaning strategy constituting a recommendation on optimally cleaning the soiling from the textile.

In addition, in action 108, a recommendation can be made on pretreatment of the textile. For certain compositions of the soiling, corresponding pretreatment may be required which is for example carried out by another device in action 110.

In action 112, the at least one output variable is prompted to be output, for example output to a display element, with in particular information regarding the composition of the soiling and at least one parameter of the cleaning strategy being displayed to the user. The user can carry out cleaning of the textile on the basis of the displayed information or recommendation.

Additionally, or alternatively, in action 114 the at least one output variable, in particular the at least one parameter of the cleaning strategy, can be output to a cleaning device. The output parameters of the cleaning strategy are used in action 116 to carry out cleaning by employing the cleaning device.

Additionally, in action 118 a soiling profile can be determined which is based at least in part on the output variable. Therefore, the determination of the at least one output variable can be designed to be adaptive, and is more precisely adjusted to the respective requirements by employing the soiling profile.

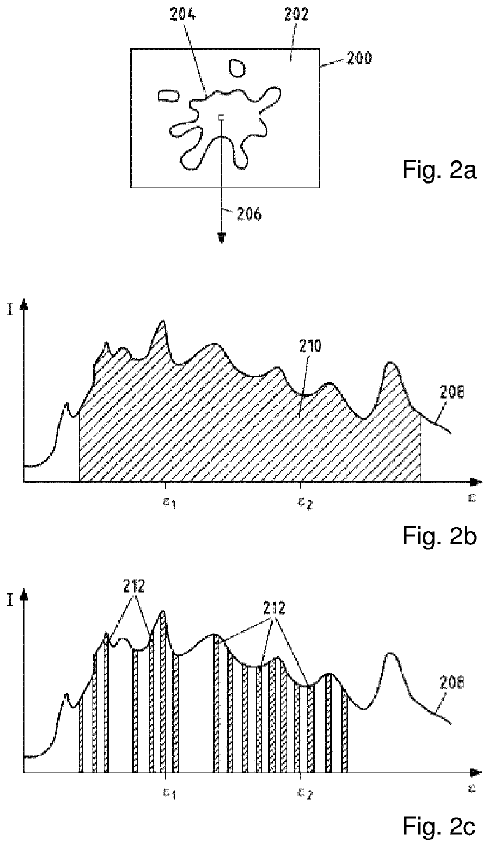

FIG. 2a schematically shows a spectral image 200 of a textile 202 with soiling 204. The spectral image 200 results in particular from the illumination of the surface of the soiling 204 by radiation, with radiation emanating from the surface of the soiling 204 in particular by reflection and emission, which radiation can be measured physically, in particular by employing an optical sensor. An intensity distribution which is representative of the spatial resolution of the spectral image 200 can be recorded in particular by employing a plurality of sensor elements, for example pixels, the pixels being arranged two-dimensionally on a surface.

FIG. 2b and FIG. 2c schematically show intensity distributions 210, 212 which are representative of spectral components of the spectral image 200. The spectrum 208 results for a limited spatial portion of the spectral image 200, represented by the arrow 206. If the spectrum 208 is measured by employing an optical sensor element, for example a pixel of an optical sensor, an intensity distribution 210 can be obtained, the intensity distribution 210 being representative of the spectral image 200 resulting from the illuminated surface of the soiling 204 on the textile 202. The intensity distribution 210 is shown in FIG. 2b as a patterned area.

The intensity distribution 210 in FIG. 2b is in this case representative of a hyperspectral image, the intensity distribution 210 comprising values in at least 20 channels up to 250 channels, each channel representing an intensity for one energy interval. The intensity distribution 210 has intensity values in channels for energy intervals, the energy intervals adjoining or overlapping one another. Thus, the intensity distribution 210 as shown in FIG. 2b is representative of an at least partially continuous spectrum.

In addition, the intensity distribution 210 is representative of spectral components of the spectral image 208, which is outside the visible energy range. The visible energy range is indicated in FIG. 2b by the lowest visible energy ε₁ and the highest visible energy ε₂. The intensity distribution 210 is in this case representative of spectral components from the infrared energy range (energy ε less than ε₁) as far as the ultraviolet energy range (energy ε greater than ε₂). This is in particular advantageous in that information which is not visible to the naked eye and is indicative of the composition of the soiling can also be recorded by employing the intensity distribution 210.

FIG. 2c schematically shows an intensity distribution 212 that is representative of a multispectral image. The intensity distribution 212, like the intensity distribution 210, likewise comprises intensity values in a plurality of channels for different energy intervals. However, the energy intervals are spaced apart and intensities of individual, distinct energies or lines are reproduced. Thus, the intensity distribution 212 is in particular not representative of a continuous spectrum. The intensity distribution 212 is also representative of spectral components from the infrared energy range as far as the ultraviolet energy range such that information that is not visible to the naked eye can also be detected therewith.

FIG. 3 shows one embodiment of a device 300 according to the second aspect and a system according to the third aspect. The device 300 is designed or comprises corresponding means for carrying out and/or controlling a method according to the first aspect. In particular, the device 300 makes it possible to identify a composition of soiling 302 on a textile 304 and/or gives a recommendation on a cleaning strategy for removing the soiling 302 from the textile 304.

Using a mobile device, in this case a smartphone 306, an intensity distribution that is representative of a spectral image resulting from the illuminated surface of the soiling 302 is initially determined. For this purpose, in particular an optical sensor 308 is used which may comprise a hyperspectral camera, for example. In addition, a radiation source 310 is provided which is used to illuminate the surface of the soiling 302. The smartphone 306 also has a display element 312.

The determined intensity distribution is received by a communication system 314. A determination device 316 designed to determine output variables that are dependent on the composition of the soiling 302 from the intensity distribution is connected to the communication system 314.

The determination of the output variables includes comparing the intensity distribution with comparative values in this case. The comparative values are stored in a database 318, which is likewise in communication with the communication system 314. The comparative values in the database 318 in particular contain intensity distributions for soiling typically occurring in a domestic setting. In addition, the database 318 contains data assigned to the comparative values in the form of a chemical composition and parameters relating to a recommended cleaning strategy that is optimal for the corresponding composition.

The output variables include parameters of a cleaning strategy of this type, the parameters specifying a type of cleaning agent, an amount of cleaning agent, a cleaning temperature, a type of cleaning device, and settings of a cleaning device 320. These output variables are displayed on the display element 312 of the smart phone 306 and are thus made available to the user. The user is therefore provided with a recommendation on a cleaning strategy that is optimal for the specific soiling 302.

The cleaning device 320 is also in communication with the communication system 314, by employing which the output variables are output to the cleaning device 320. The cleaning device 320 comprises a display element 322, which in particular can display the output variables. In addition, the cleaning device 320 comprises a dosing device 324 for the cleaning agent. In this case, the dosing device 324 can provide a cleaning agent in accordance with the parameters of the cleaning strategy in relation to the type of cleaning agent and/or the amount of cleaning agent, or may check whether the dosing device 324 has been filled with the cleaning agent in accordance with the recommended cleaning strategy.

In addition, the cleaning device 320 comprises a control element 326 which allows the cleaning device 320 to be controlled by a user. Here, the cleaning device 320 adopts the parameters of the cleaning strategy as a preset. The user then has the choice either to follow the recommendation on the cleaning strategy and simply start the cleaning device 320 by employing the control element 326, or to manually set the cleaning device 320 themselves by employing the control element 326. The cleaning is carried out in a cleaning container 328, in this case a washing drum.

In addition, FIG. 3 shows a determination device 330. The determination device 330 comprises sensor elements 332 and optionally at least one illumination means (not shown). The determination device has a spherical shape and is designed to be arranged in the cleaning container 328 while cleaning is being carried out. In this case, the determination device 330 is freely movable and is resistant to the action of the washing solution in the cleaning container 328. The determination device 330 can therefore provide intensity distributions for the soiling 302 during a cleaning process in order to monitor the cleaning strategy. The determination device 330 can also determine intensity distributions for soluble, non-fixed textile dyes in the washing solution. Therefore, the corresponding textile dyes dissolving out of the textile 304 can be monitored.

FIG. 4 is a block diagram of one embodiment of a device 400, which in particular can carry out an exemplary method according to the first aspect. The device 400 is for example a device according to the second aspect or a system according to the third aspect. In this respect, the device 400 may for example be a computer, a desktop computer, a server, a thin client or a portable computer (mobile device), such as a laptop computer, a tablet computer, a wearable, a personal digital assistant (PDA) or a smartphone. The device may for example perform the function of a server or a client.

The processor 410 of the device 400 is in particular designed as a microprocessor, a microcontrol unit, a microcontroller, a digital signal processor (DSP), an application-specific integrated circuit (ASIC) or a field programmable gate array (FPGA).

The processor 410 executes program instructions that are stored in the program memory 412, and for example stores intermediate results or the like in a working memory or main memory 411. For example, the program memory 412 is a non-volatile memory such as a flash memory, a magnetic memory, an EEPROM memory (electrically erasable programmable read-only memory), and/or an optical memory. The main memory 411 is for example a volatile or non-volatile memory, in particular a memory with random access (RAM) such as a static RAM memory (SRAM), a dynamic RAM memory (DRAM), a ferroelectric RAM memory (FeRAM), and/or a magnetic RAM memory (MRAM).

The program memory 412 is preferably a local data carrier that is permanently connected to the device 400. Data carriers that are permanently connected to the device 400 are for example hard drives that are integrated in the device 400. Alternatively, the data carrier may for example also be a data carrier that can be detachably connected to the device 400, such as a memory stick, a removable storage device, a portable hard drive, a CD, a DVD, and/or a floppy disk.

The program memory 412 for example contains the operating system of the device 400, which is loaded in the main memory 411 at least in part and is executed by the processor 410 when the device 400 is started up. In particular, when the device 400 is started up, at least part of the core of the operating system is loaded in the main memory 411 and executed by the processor 410. The operating system of the device 400 is for example a Windows, UNIX, Linux, Android, Apple iOS and/or MAC operating system. The operating system in particular allows the device 400 to be used for data processing. It for example manages operating equipment such as the main memory 411 and the program memory 412, the network interface 413, and the input and output apparatus 414, makes basic functions available to other programs inter alia by programming interfaces, and controls the execution of programs.

The processor 410 controls the communication interface 413, which for example may be a network interface and may be designed as a network card, network module, and/or modem. The communication interface 413 is in particular designed to establish a connection between the device 400 and other devices, in particular via a (wireless) communication system, for example a network, and to communicate therewith. The communication interface 413 may for example receive data (via the communication system) and forward said data to the processor 410, and/or receive data from the processor 410 and transmit said data (via the communication system). Examples of a communication system are a local network (LAN), a wide area network (WAN), a wireless network (for example in accordance with the IEEE-802.11 standard, the Bluetooth (LE) standard and/or the NFC standard), a wired network, a mobile network, a telephone network, and/or the Internet.

Furthermore, the processor 410 can control at least one input/output apparatus 414. An input/output apparatus 414 is for example a keyboard, a mouse, a display unit, a microphone, a touch-sensitive display unit, a speaker, a read apparatus, a drive, and/or a camera. An input/output apparatus 414 may for example receive user inputs and forward said inputs to the processor 410, and/or receive and output information for the user of the processor 410.

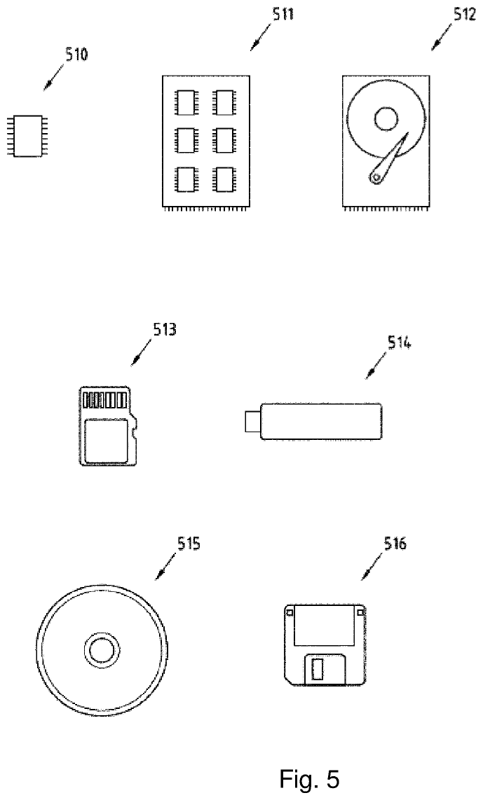

Finally, FIG. 5 shows different embodiments of memory media on which one embodiment of a computer program as contemplated herein can be stored. The memory medium may for example be a magnetic, electrical, optical and/or different kind of memory medium. The memory medium may for example be part of a processor (e.g. the processor 410 in FIG. 4), for example a (non-volatile or volatile) program memory of the processor, or a part thereof (such as the program memory 412 in FIG. 4). Embodiments of a memory medium are a flash memory 510, an SSD hard drive 511, a magnetic hard drive 512, a memory card 513, a memory stick 514 (e.g. a USB stick), a CD-ROM or DVD 515, or a floppy disk 516.

The following embodiments are also to be understood as disclosed:

### Embodiment 1

1. Method carried out by one or more devices, comprising:

obtaining intensity information (210, 212) representative of a spectral image (208) resulting from soiling (204, 302) of a textile (202, 304);

determining at least one output variable that is dependent on the composition of the soiling (204, 302) on the basis of the intensity information (210, 212); and

outputting or triggering the output of the at least one output variable.

### Embodiment 2

Method according to embodiment 1, wherein the intensity information (210, 212) is representative of a spectral image (208) resulting from an illuminated surface of the soiling (204, 302) on a textile (202, 304).

### Embodiment 3

Method according to embodiment 1 or 2, wherein the at least one output variable comprises at least one parameter of a cleaning strategy of the textile.

### Embodiment 4

Method according to embodiment 3, wherein the at least one parameter of the cleaning strategy constitutes a type of cleaning agent, an amount of cleaning agent, a cleaning temperature, a type of cleaning device, settings of a cleaning device (320) or combinations thereof.

### Embodiment 5

Method according to embodiment 3 or 4, wherein the at least one parameter of the cleaning strategy includes a recommendation on pretreatment of the soiling (204, 302).

### Embodiment 6

Method according to one of embodiments 3 to 5, the method further comprising:

carrying out the cleaning strategy by employing a cleaning device (320).

### Embodiment 7

Method according to one of embodiments 1 to 6, wherein the at least one output variable is output to a cleaning device (320).

### Embodiment 8

Method according to one of embodiments 1 to 7, wherein the determination of the at least one output variable includes comparing the intensity information (210, 212) with comparative values.

### Embodiment 9

Method according to one of embodiments 1 to 8, the method further comprising:

determining the intensity information (210, 212) by employing an optical sensor (308).

### Embodiment 10

Method according to one of embodiments 1 to 9, the method further comprising:

determining a soiling profile based at least in part on the output variable, in particular based on a plurality of determined output variables,

wherein the determination of the at least one output variable is based at least in part on the soiling profile.

### Embodiment 11

Method according to one of embodiments 1 to 10, wherein at least one of the devices for carrying out the method is a mobile device (306).

### Embodiment 12

Method according to one of embodiments 1 to 11, wherein the intensity information (210) is representative of a hyperspectral image.

### Embodiment 13

Method according to one of embodiments 1 to 12, wherein the intensity information (210, 212) comprises values in at least 20 channels, wherein each channel represents an intensity for one energy interval.

### Embodiment 14

Method according to one of embodiments 1 to 13, wherein the intensity information (210, 212) is representative of spectral components of a spectral image (200), wherein at least one of the spectral components lies outside the visible energy range.

### Embodiment 15

Method according to embodiment 14, wherein the intensity information (210, 212) is representative of spectral components of a spectral image (200) from the infrared energy range as far as the ultraviolet energy range.

### Embodiment 16

Method according to one of embodiments 1 to 15, wherein the intensity information (210, 212) is representative of spatially resolved components of a spectral image (200).

### Embodiment 17

Device that is designed or comprises corresponding means for carrying out and/or controlling a method according to one of embodiments 1 to 16.

### Embodiment 18

Device comprising at least one processor (410) and at least one memory (411, 412) comprising computer program code, wherein the at least one memory (411, 412) and the computer program code are designed to carry out and/or control at least one method according to one of embodiments 1 to 16 using the at least one processor (410).

### Embodiment 19

Computer program comprising program instructions that prompt a processor (410) to execute and/or control a method according to one of embodiments 1 to 16 when the computer program is running on the processor (410).

### Embodiment 20

Computer-readable memory medium which contains a computer program according to embodiment 19.

### Embodiment 21

System comprising:

a plurality of devices (306, 314, 316, 318, 320), in particular at least one mobile device (306) and a cleaning device (320), which together carry out a method according to one of embodiments 1 to 16.

The embodiments of the present disclosure described in this specification and the optional features and properties set out in this regard are also intended to be understood to be disclosed in any combination with one another. In particular, unless explicitly stated otherwise, the description of a feature included in an embodiment should not be understood in the present case to mean that the feature is indispensable or essential for the function of the embodiment. The sequence of the method steps set out in this specification in the individual flow diagrams is not compulsory, and alternative sequences of the method steps are conceivable. The method steps can be implemented in different ways, and therefore implementation in software (by employing program instructions), hardware, or a combination of the two are conceivable for implementing the method steps.

Terms used in the claims such as “include”, “comprise”, “contain” and the like do not exclude additional elements or steps. The wording “at least in part” covers both “in part” and “completely”. The wording “and/or” is intended to be understood such that both the alternative and the combination are intended to be disclosed, i.e. “A and/or B” means “(A) or (B) or (A and B)”. The use of the indefinite article does not exclude a plurality. A single device can perform the functions of a plurality of units or devices mentioned in the claims. Reference signs in the claims should not be considered limiting to the means and steps used.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A method for determining a cleaning strategy for a soiled textile, the method comprising:
obtaining intensity information representative of a spectral image resulting from soiling of a textile;
determining at least one output variable that is dependent on the composition of the soiling on the basis of the intensity information; and
outputting or triggering the output of the at least one output variable.

2. The method according to claim 1, wherein the intensity information is representative of a spectral image resulting from an illuminated surface of the soiling on a textile.

3. The method according to claim 1, wherein the at least one output variable comprises at least one parameter of a cleaning strategy of the textile.

4. The method according to claim 3, wherein the at least one parameter of the cleaning strategy constitutes a type of cleaning agent, an amount of cleaning agent, a cleaning temperature, a type of cleaning device, settings of a cleaning device or combinations thereof, and/or wherein the at least one parameter of the cleaning strategy includes a recommendation on pretreatment of the soiling.

5. The method according to claim 3, the method further comprising:
carrying out the cleaning strategy by means of a cleaning device.

6. The method according to claim 1, wherein the determination of the at least one output variable includes comparing the intensity information with comparative values.

7. The method according to claim 1, the method further comprising:
determining the intensity information by means of an optical sensor.

8. The method according to claim 1, the method further comprising:
determining a soiling profile based at least in part on the output variable, in particular based on a plurality of determined output variables,
wherein the determination of the at least one output variable is based at least in part on the soiling profile.

9. The method according to claim 1, wherein the intensity information is representative of a hyperspectral image.

10. The method according to claim 1, wherein the intensity information comprises values in at least 20 channels, wherein each channel represents an intensity for one energy interval.

11. The method according to claim 1, wherein the intensity information is representative of spectral components of a spectral image, wherein at least one of the spectral components lies outside the visible energy range.

12. The method according to claim 11, wherein the intensity information is representative of spectral components of a spectral image from the infrared energy range as far as the ultraviolet energy range.

13. The method according to claim 1, wherein the intensity information is representative of spatially resolved components of a spectral image.

14. A device that is designed or comprises corresponding means for carrying out and/or controlling a method according to claim 1.

15. A system comprising:
a plurality of devices, including at least one mobile device and a cleaning device, which together carry out a method according to claim 1.
